(19) United States
(12) Patent Application Publication
(10) Pub. No.: US 2016/0025246 A1
(43) Pub. Date: Jan. 28, 2016

(54) SPRAYER HOSE ASSEMBLY

(71) Applicant: MASCO CORPORATION OF INDIANA, Indianapolis, IN (US)

(72) Inventors: Alfred Charles NELSON, Westfield, IN (US); Kurt Judson THOMAS, Indianapolis, IN (US); Jeffrey L. MOORE, Frankfort, IN (US); Kyle Robert DAVIDSON, Noblesville, IN (US)

(21) Appl. No.: 14/776,550

(22) PCT Filed: Mar. 14, 2014
(86) PCT No.: PCT/US2014/028097

§ 371 Date: Sep. 14, 2015

Related U.S. Application Data
(60) Provisional application No. 61/791,227, filed on Mar. 15, 2013.

(51) Int. Cl. F16L 11/127; F16L 33/207; G02B 6/50; E03C 1/04; F21V 8/00; F16L 11/02; E03C 1/02

(52) U.S. Cl. CPC F16L 11/127; F16L 11/02; F16L 33/2071; E03C 1/021; E03C 1/0404; G02B 6/001; G02B 6/502

(57) ABSTRACT

A sprayer hose assembly including an inner tube, an outer sheath, and an energy conducting conduit extending along the outer sheath.

### RELATED APPLICATION

This application claims the benefit of U.S. Provisional Application Ser. No. 61/791,227, filed Mar. 15, 2013, docket DFC-4428-01, titled SPRAYER HOSE ASSEMBLY, the entire disclosure of which is expressly incorporated by reference herein.

### BACKGROUND AND SUMMARY OF DISCLOSURE

Dual-layered hoses having an overbraiding and a resilient interior tube are well known in the art of faucets, especially kitchen faucets with pullout wands. The overbraiding, usually constructed from interwoven nylon, polymeric, or metal threads, forms a supportive external layer for the resilient tube. This combination allows a user to flex and deform the hose when adjusting the water stream. While nylon, polymeric, or metal threads are typically used for the overbraiding, other materials can be used or combined in the braid. An illustrative hose assembly is described in US Patent Application Publication No. 2009/0126820 to Thomas et al., the disclosure of which is expressly incorporated by reference herein.

Further, since the hose has the overbraiding layer over the tube, there can be a narrow space between the overbraiding and the tube that can facilitate the passage of thread-like material along the length of the hose. Both the interweaving of different materials and the feeding of fibers and wiring between the layers make beneficial modifications to the hose possible.

For example, optical fibers can be as thin as a strand of human hair and they possess thread-like qualities that make them adaptable to the overbraiding of a faucet hose. Optical fibers can transmit light to provide both decorative and functional uses. Usually constructed of either transparent glass or plastic, they can be made to be flexible and deformable. These fibers can both transmit light between the two ends of the fiber and/or exteriorly along the axial exterior of the fiber.

Further, activation sensors may be desired in electronic faucets and require coupling to power sources and/or controllers through electrical wires. In certain embodiment faucets, it is desired to provide sensors on pull-out sprayheads removably supported by a delivery spout. As such, it is desired for electrical wires to pass along the hose in a protected and aesthetically pleasing manner.

The present disclosure provides an improved faucet hose by adding energy conducting conduits, such as optical fibers and/or electrical wires along a sprayer hose.

In one illustrative embodiment, a water faucet hose assembly is provided. In one exemplary embodiment, the assembly includes a first fiber formed of a first material, a second fiber formed of a second material configured to conduct energy, the first fiber and the second fiber being interwoven with one another to define a braided exterior sheath defining a longitudinal axis. The assembly further includes a resilient interior tube concentrically received within said sheath.

In another illustrative embodiment, a water faucet hose assembly is provided. In one exemplary embodiment, the assembly includes an exterior sheath defining a longitudinal axis, a resilient interior tube concentrically received within the sheath, and a space defined between the sheath and said tube. The space extends parallel to the exterior sheath and the resilient interior tube. The assembly further includes at least one energy conducting conduit extending through the space. In a more particular embodiment, the exterior sheath is a polymer braid.

In another illustrative embodiment, a water faucet hose assembly is provided. In one exemplary embodiment, the assembly includes a resilient interior tube having a fluid conduit extending therethrough, an exterior sheath covering a length of the resilient interior tube, the exterior tube being constructed of braided threads, and at least one energy conducting conduit positioned between the exterior sheath and the resilient interior tube. The exterior sheath includes a radial outlet through which the energy conducting conduit extends. The radial outlet is proximate to a first end of the exterior sheath and spaced apart from the first end of the exterior sheath.

In another illustrative embodiment, a water faucet spray assembly is provided. In one exemplary embodiment, the assembly includes a hose assembly including a fluid conduit, at least one energy conducting conduit, and an exterior sheath, the fluid conduit and the at least one energy conducting conduit being covered along at least a portion of the hose assembly by the exterior sheath. The assembly further includes a waterway having a fluid inlet and at least one fluid outlet, the fluid inlet of the waterway being in fluid communication with the fluid conduit of the hose assembly. The assembly further includes at least one sensor coupled to the least one energy conducting conduit, the at least one sensor including at least one of a touch sensor and a proximity sensor, and a retainer removably coupled to the hose assembly and the waterway, the retainer having a conduit guide which receives and routes the at least one energy conducting conduit of the hose assembly between the hose assembly and the at least one sensor.

In another illustrative embodiment, a water faucet sprayer assembly is provided. In one exemplary embodiment, the assembly includes a hose assembly including a fluid conduit, at least one energy conducting conduit, and an exterior sheath, the fluid conduit and the at least one energy conducting conduit being covered along at least a portion of the hose assembly by the exterior sheath. The assembly further includes a waterway having a fluid inlet and at least one fluid outlets, the fluid inlet of the waterway being in fluid communication with the fluid conduit of the hose assembly, at least one sensor coupled to the least one energy conducting conduit, the at least one sensor including at least one of a touch sensor and a proximity sensor, and a retainer removably coupled to the hose assembly and the waterway, the retainer maintaining an axial position of the waterway relative to a longitudinal axis of the hose assembly and a rotational position of the waterway relative to the longitudinal axis of the hose assembly.

In another illustrative embodiment, a method of coupling a waterway of a pull-out portion of a faucet to a hose assembly that is moveably received within a body portion of the faucet, the hose assembly including a fluid conduit, at least one energy conducting conduit, and an exterior sheath, the fluid conduit and the at least one energy conducting conduit being covered along at least a portion of the hose assembly by the exterior sheath is provided. The method includes positioning the waterway relative to the hose assembly to place a fluid inlet of the waterway in fluid communication with the fluid conduit of the hose assembly, securing a removable retainer to the hose assembly and the waterway to retain the waterway relative to the hose assembly, and coupling the at least one energy conducting conduit of the hose assembly to at least one sensor of the pull-out portion of the faucet, the at least one sensor including at least one of a touch sensor and a proximity sensor.

### BRIEF DESCRIPTION OF THE DRAWINGS

The above-mentioned and other features of the disclosure, and the manner of attaining them, will become more apparent and will be better understood by reference to the following description of embodiments of the disclosure taken in conjunction with the accompanying drawings, wherein:

FIG. 1 illustrates a side view of an illustrative hose of the present disclosure;

FIG. 2 illustrates another side view of the hose of FIG. 1;

FIG. 2A illustrates a sectional view of another illustrative hose;

FIG. 3 illustrates a schematic of the hose of FIG. 1;

FIG. 4 illustrates a perspective view of an illustrative sprayhead for use with the hose of FIG. 1;

FIG. 5 illustrates a perspective view in cross-section of the sprayhead of FIG. 4;

FIG. 6 illustrates a perspective view of an exemplary sprayer assembly of a faucet and an exemplary hose;

FIG. 7 illustrates an exploded view of the sprayer assembly of FIG. 6;

FIG. 8 illustrates a perspective view of the sprayer assembly of FIG. 6 with an adaptor coupled to the hose and in fluid communication with a waterway;

FIG. 9 illustrates the assembly of FIG. 8 with a retainer coupled to the adaptor and to the waterway;

FIG. 9A illustrates a sectional view along lines 9A-9A in FIG. 9;

FIG. 10 illustrates the assembly of FIG. 9 with a cover positioned over the wires extending out of the hose;

FIG. 11 illustrates the assembly of FIG. 10 with a sprayer head connector assembled;

FIG. 12 illustrates a sectional view along lines 12-12 in FIG. 6;

FIG. 13 is a partial, cutaway view of the sprayer assembly of FIG. 6;

FIG. 13A illustrates a sectional view along lines 13A-13A in FIG. 13;

FIG. 14 illustrates a sectional view along lines 14-14 in FIG. 8;

FIG. 15 illustrates the hose assembly of FIG. 6 and associated sensors; and

FIG. 16 illustrates a schematic representation of the electrical connections of the hose assembly of FIG. 6.

Corresponding reference characters indicate corresponding parts throughout the several views. The exemplifications set out herein illustrate embodiments of the disclosure and such exemplifications are not to be construed as limiting the scope of the invention in any manner.

### DETAILED DESCRIPTION OF THE DRAWINGS

The embodiments of the invention described herein are not intended to be exhaustive or to limit the invention to precise forms disclosed. Rather, the embodiments elected for description have been chosen to enable one skilled in the art to practice the invention.

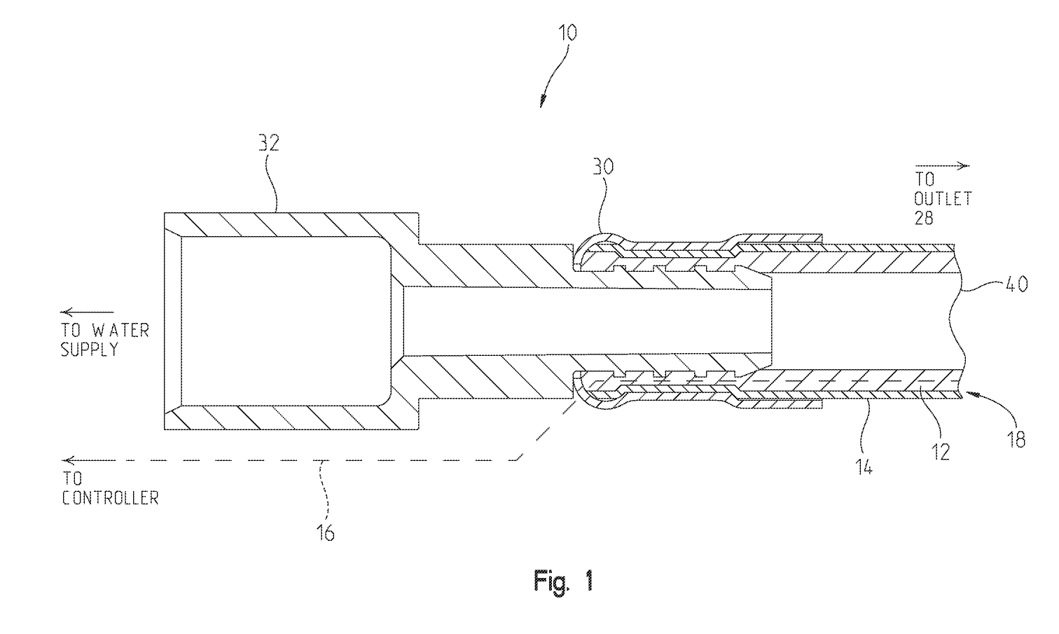

Faucet hoses can be modified either by interweaving fibers into the overbraiding or passing fibers and wiring along the hose length between the multiple layers of the hose. In general, referring to FIG. 1, hose assembly 10 is illustrated as including both tube 12 and overbraiding 14. Optical fiber 16 can extend along the length of hose 10 either by being interwoven with overbraiding 14 or being threaded through space 18. Also, referring to FIG. 3, wires for electrical components supported within a pullout sprayhead 24, such as a capacitive sensor 20 and an ultrasonic sensor 22, may extend through space 18 along with optical fiber 16.

Referring back to FIG. 1, tube 12 defines a fluid passageway 40 through which water flows in from a water source (not shown) and out through pullout sprayhead 24. Typically, tube 12 is constructed of a material that is water-impermeable, elastically deformable, and resilient, such as rubber, plastic, or another synthetic polymer. This resilience facilitates the flexibility that pullout sprayhead 24, for example, provides when obtaining different spray angles is desirable. In one illustrative embodiment, the tube 12 is formed of a cross-linked polyethylene (PEX).

Tube 12 may be subjected to significant water pressure when in use. Thus, overbraiding 14, constructed of braided threads, provides an outer reinforcing sheath or outer sleeve for tube 12. Hose assembly 10, combining tube 12 and overbraiding 14, is resiliently adaptable to the deformations that result from angling or bending hose 10 and the water pressure that builds up within tube 12.

Since overbraiding 14 is constructed of interconnected, illustratively interwoven or braided threads, various materials may be utlized in overbraiding 14. For example, nylon threads can be combined with threads of a different material having similar physical characteristics, such as polypropylene for example, to create an interwoven composite. Advantageously then, given this compatibility of overbraiding 14 with diverse materials, such as energy conducting conduits, illustratively an optical fiber 16, may be interwoven with the other threads in overbraiding 14 to extend along the length of hose 10.

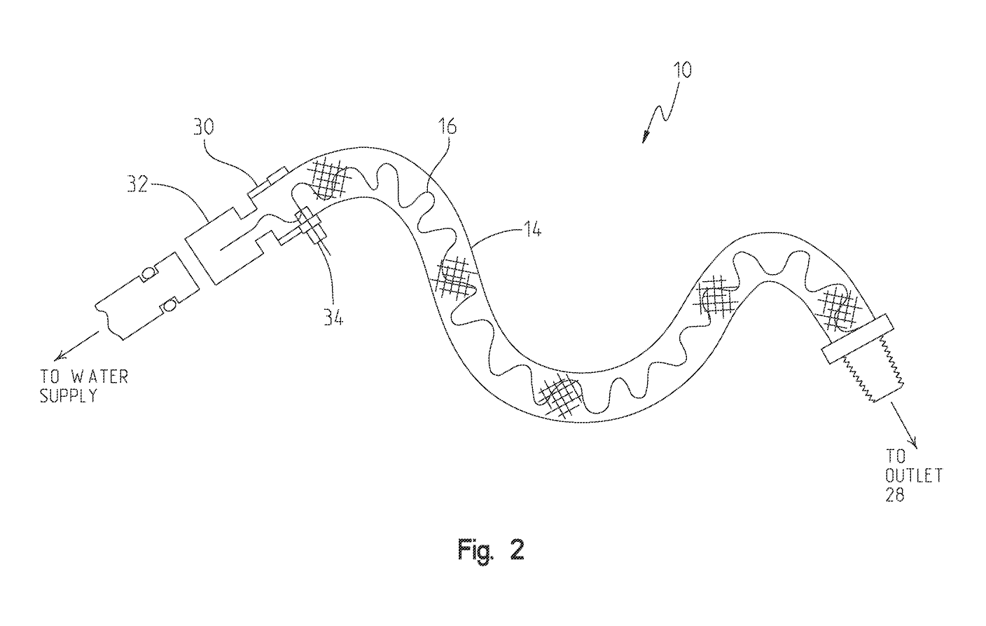

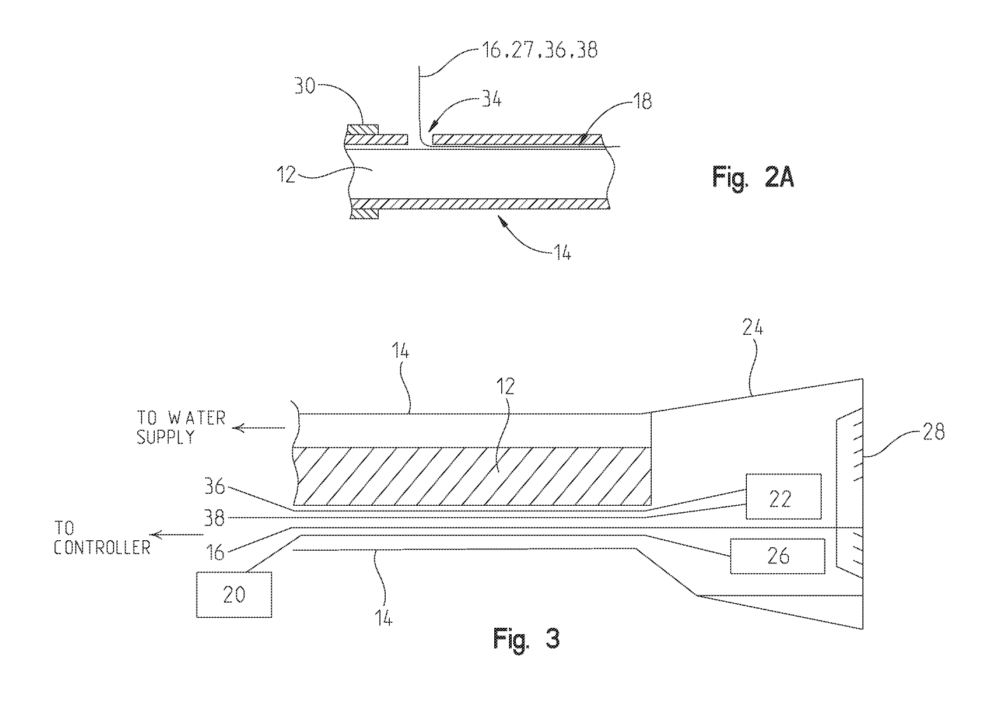

Therefore, in one embodiment, referring to FIG. 2, optical fiber 16 is interwoven into the threads of overbraiding 14. By interweaving optical fiber 16, light can be distributed along overbraiding 14 in different ways. First, optical fiber 16 may transmit light from one end to the other to illuminate pullout wand 24 (shown in FIG. 3) at the spraying end. This “end-to-end” spanning transmits light virtually uninhibited toward outlet 28. Alternatively, or in addition to the first method, optical fiber 16 may also be nicked or notched along its axial length to decrease the internal reflection and allow light to escape radially outwardly through the outer surface of optical fiber 16. This “interspaced” lighting transmits several small beams of light along the length to provide an aesthetically pleasing, illuminated hose 10.

Optical fiber 16 can extend along the length of hose 10 in another manner. Referring back to FIG. 1, hose 10 has space 18 between tube 12 and overbraiding 14 that is of sufficient size to receive energy conducting conduits, such as thin electrical wires or fibers. Thus, in an alternate embodiment, instead of interweaving optical fiber 16 into overbraiding 14, optical fiber 16 may be positioned between overbraiding 14 and tube 12 along the length of hose 10. By “sandwiching” optical fiber 16 between overbraiding 14 and tube 12, this embodiment facilitates the transmission of light from one end of optical fiber 16 to the other to illuminate the end of pullout wand 24 and transmit light virtually uninhibited toward outlet 28. Referring to FIG. 2A, the optical fiber 16, and/or wires 27, 36, 38, are positioned in space 18 between overbraiding 14 and tube 12. In the exemplary embodiment illustrated in FIG. 2A, radial outlet 34 is an inlet for optical fiber 16 and/or wires 27, 36, 38 that intersects hose 10 at a location along the length of hose 10 that is past ferrule 30. Thus, ferrule 30 can still be crimped as usual without damaging the optical fiber 16, and/or wires 27, 36, 38.

Referring to FIG. 3, multiple wires may extend along the length of hose 10 allowing for a multi-sensor arrangement in pullout wand 24 with an optional fiber-optically transmitted light. In one illustrative embodiment, these wires connect electrode 26 to capacitive sensor 20, connect power and ground, 36 and 38, to ultrasonic sensor 22, and, optionally, transmit light out through pullout wand 24 via optical fiber 16. Space 18 is defined between overbraiding 14 and the exterior of tube 12 (represented by diagonal lines in FIG. 3) to allow the passage of these fibers or wires along the length of hose 10.

Referring further to FIG. 3, illustrative hose assembly 10 is further shown. Overbraiding 14 constitutes the exterior layer of hose 10 and covers tube 12 while providing space 18 between the inner surface of overbraiding 14 and the outer surface of tube 12. Advantageously, with wiring threaded through space 18, as illustrated and as will be described in further detail below, electrode 26 and ultrasonic sensor 22 can both be positioned conveniently within pullout wand 24.

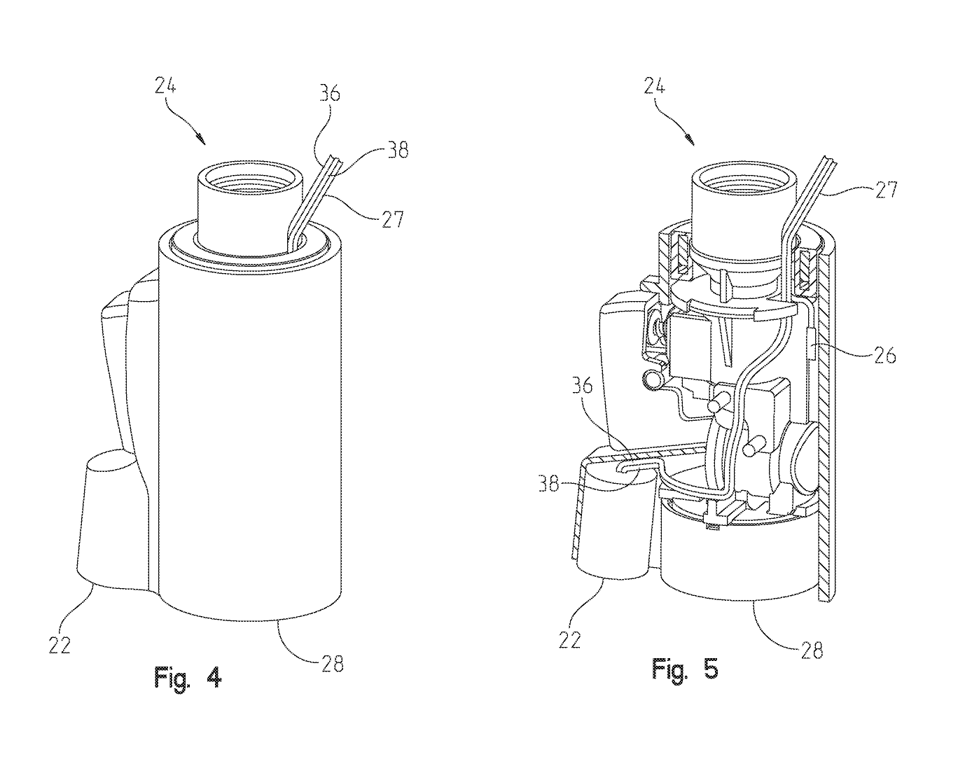

With reference to FIGS. 4 and 5, while capacitive sensors are capable of both touch-sensing and proximity-sensing, capacitive sensor 20, in a simplified exemplary embodiment, detects the touching of pullout wand 24 to turn the water stream on. Electrode 26, contained within and in electrical communication with pullout wand 24, is electrically coupled to capacitive sensor 20 through a wire 27. Advantageously, electrode is positioned adjacent outlet 28 of pullout wand 24 such that the distance between the stream and the surface that a user touches has been minimized. In an exemplary operation, a capacitive signal is constantly transmitted from electrode 26 to capacitive sensor 20. When a user touches the exterior of pullout wand 24, this contact changes the capacitive signal that is transmitted to the capacitive sensor 20. Capacitive sensor 20 transmits a signal to a processor that controls the opening and closing of an electrically operable valve to turn the water stream on.

In an illustrative embodiment, ultrasonic sensor 22 turns the water stream on when an object comes within a predetermined proximity. Two wires, power 36 and ground 38, are threaded through space 18 along the length of hose 10 and connected to ultrasonic sensor 22, which is positioned in pullout wand 24. Advantageously, this threading through hose 10 allows for the simple construction of an easily accessible sensor not only for a user's hands, but also for objects placed in close proximity of ultrasonic sensor 22. In an exemplary operation, ultrasonic sensor 22 transmits a burst of ultrasonic waves at an object that are, in turn, deflected back toward the sensor 22. This deflected burst, also known as an echo, is detected by circuitry connected to ultrasonic sensor 22. This circuitry transmits the echo as a signal that identifies the proximity to a processor that controls the opening and closing of a valve to turn the water stream on.

By utilizing space 18 to receive the wiring for both capacitive sensor 20 and ultrasonic sensor 22, a more compact design for pullout wand 24 and hose 10 can be achieved. Having both sensors positioned near outlet 28 allows the sensors 20 and 22 to be close to the stream at outlet 28.

Referring now to FIGS. 1 and 2, in a typical faucet assembly, hose 10 has ferrule 30 that is usually crimped and fixedly connected to the end of hose 10 to secure hose 10 to water source adapter 32 that leads to water source (not shown). This crimping process form fits or bends the circular edges of ferrule 30 so that it is pressed like a collar against the end of hose 10 to secure tube 12 and overbraiding 14 to one another and to water source adapter 32.

However, when optical fiber 16 is interwoven into overbraiding 14 or any fibers or wires extend through space 18, such a form fit could damage those fibers and/or wires. Thus, referring now to FIG. 2, two ways for directing the fibers and wires to avoid damage from the crimping process are illustrated. First, radial outlet 34 is an inlet for fibers and/or wires that intersects hose 10 at a location along the length of hose 10 that is past ferrule 30. Thus, ferrule 30 can still be crimped as usual without damaging the fibers and/or wires. Second, an alternative crimping process can be utilized. Instead of pressing the full circular edges of ferrule 30 against hose 10, a portion of the circular edge is left uncrimped so that fibers and/or wires can extend through the remaining opened portion of the circular edge.

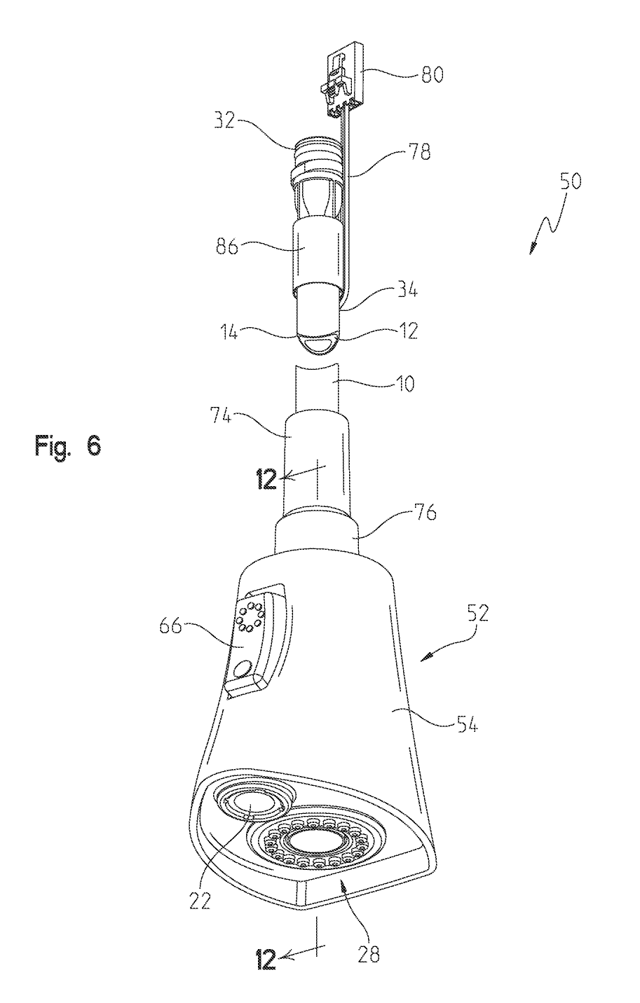

Referring now to FIG. 6, sprayer assembly 50 illustratively includes hose assembly 10 fluidly coupled to pullout sprayhead 52. Sprayer assembly 50 includes a water source adapter 32 configured to fluidly couple tube 10 to a water supply. Hose assembly 10 is configured to fluidly couple the water supply to one or more fluid outlets 28 in sprayhead 52.

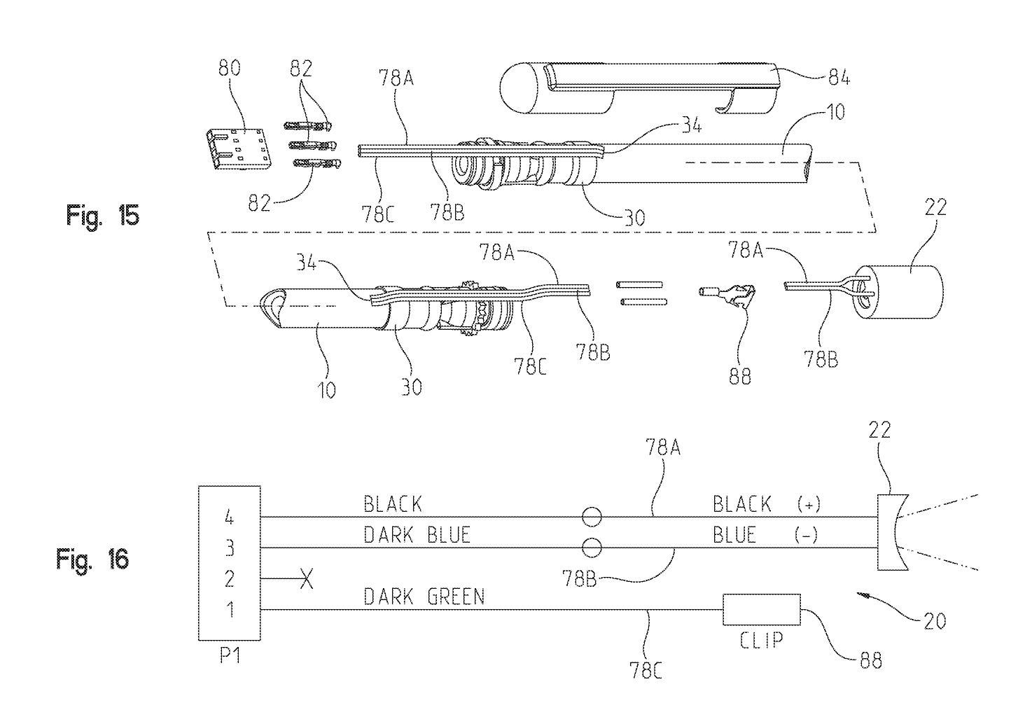

Referring to FIGS. 14-16, hose assembly further includes at least one energy conducting conduit 78 extending in a space 18 defined between tube 12 and overbraiding 14 of tube assembly 10. Energy conducting conduit 78 is illustratively one or more wires, such as wires 78A, 78B, 78C, or an optical fiber. Referring to FIG. 6, conduit 78 exits space 18 at radial outlet 34. Radial outlet 34 is illustratively spaced apart from water source adapter 32. In the exemplary embodiment of FIG. 15, a ferrule 30 is positioned over the overbraiding 14 of hose assembly 10, securing water source adapter 32 to hose assembly 10. In the illustrative embodiment, ferrule 30 is positioned closer to the end of hose assembly 10 nearer the water source adapter 32 than the radial outlet 34. A second radial outlet 34 may be spaced apart from waterway adapter 61. In one exemplary embodiment, a ferrule 30 is positioned over the overbraiding 14 of hose assembly 10, securing waterway adapter 61 to hose assembly 10. In the exemplary embodiment, ferrule 30 is positioned closer to the end of hose assembly 10 nearer the waterway adapter 61 than the radial outlet 34.

Conduits 78 are illustratively secured to connector 80 by connector pins 82 , as shown in FIG. 15. In the exemplary embodiment shown in FIG. 15, the water source adapter 32 and radial outlet 34 is covered by a protective sheath 84. In the illustrative embodiment, the protective sheath 84 is coupled around water source adapter 32 and radial outlet 34 during installation of hose assembly 10 in a faucet, and removed prior to use of the faucet.

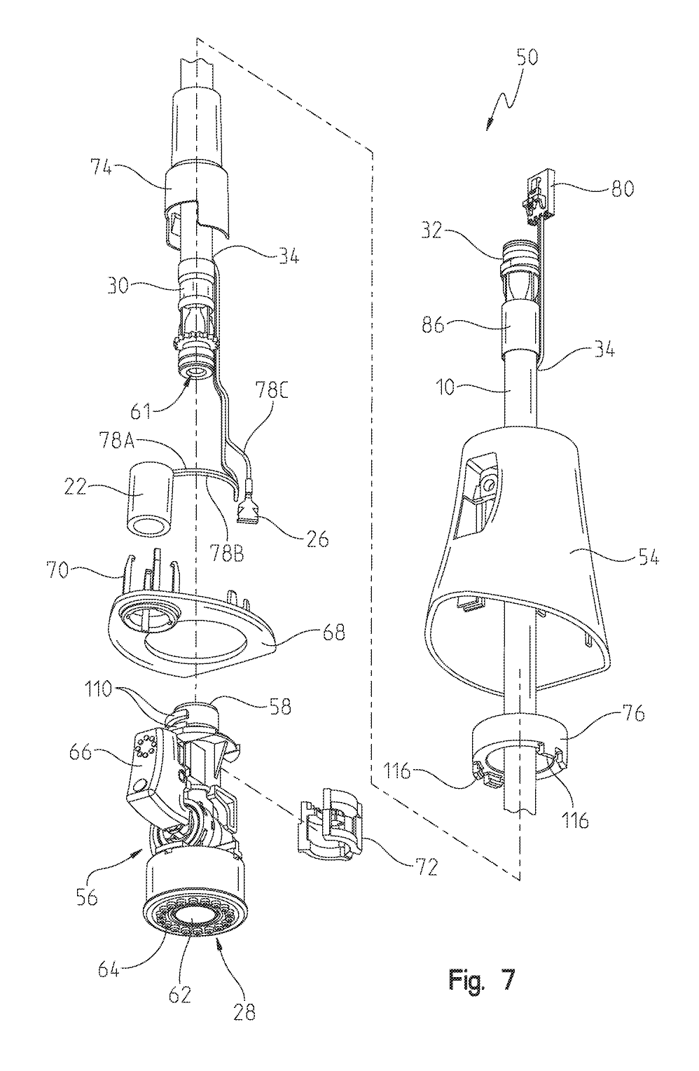

In the exemplary embodiment illustrated in FIG. 7, sprayhead 52 includes a cover 54 at least partially covering waterway 56. Waterway 56 includes a fluid inlet 58 in fluid communication with a fluid conduit 60 of hose assembly 10. In one exemplary embodiment, waterway 56 includes a plurality of outlets, such as the central stream outlet 62 and plurality of spray outlets 64 surrounding stream outlet 62 illustrated in FIG. 7. Waterway 56 illustratively includes diverter valve 66 selectively placing fluid inlet 58 in fluid communication with either the central stream outlet 62 or the spray outlet 64. As illustrated in FIG. 6, diverter valve 66 may be accessible to a user through cover 54.

In the exemplary embodiment illustrated in FIG. 7, sprayhead 52 further includes a base 68 forming at least a bottom surface of sprayhead 52. Base 68 illustratively includes a plurality of apertures for receiving waterway 56 and ultrasonic sensor 22. As illustrated, base 68 includes basket 70 for receiving and securing ultrasonic sensor 22 to base 68.

Referring to FIG. 6, in one illustrative embodiment, radial outlet 34 and a portion of water source adapter 32 are covered by protective sleeve 86.

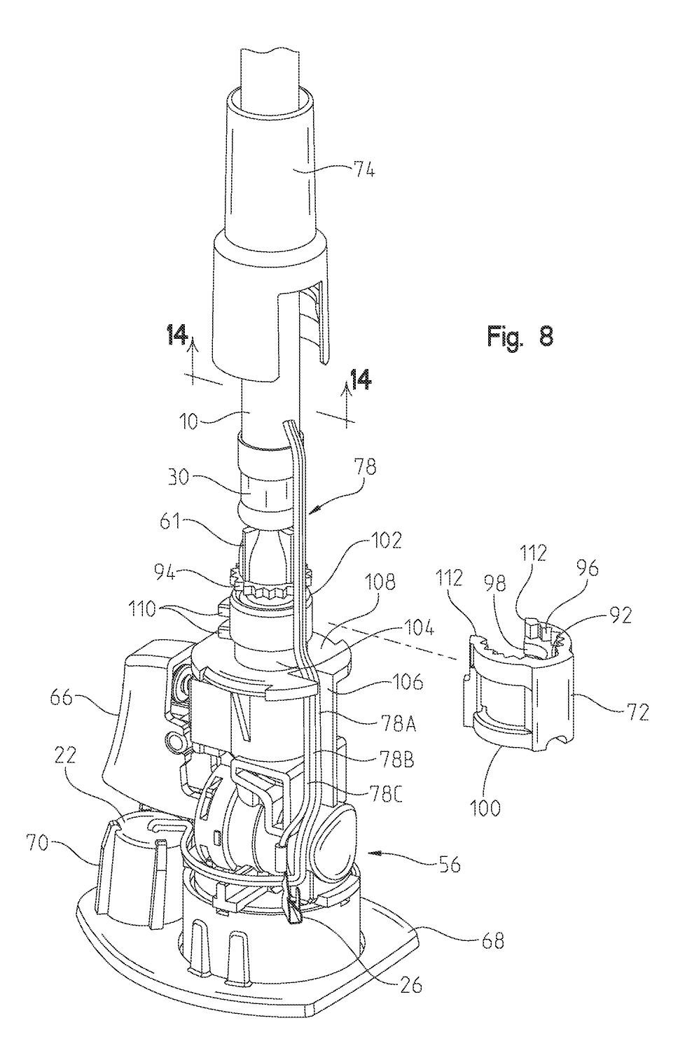

As illustrated in FIGS. 7 and 8, waterway adapter 61 is inserted into fluid inlet 58 of waterway 56.

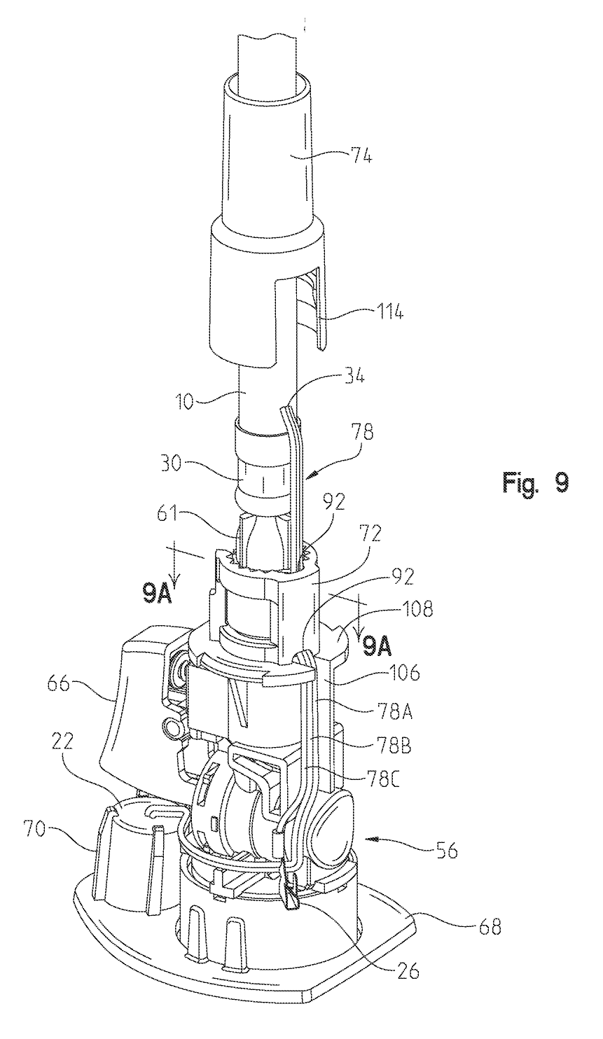

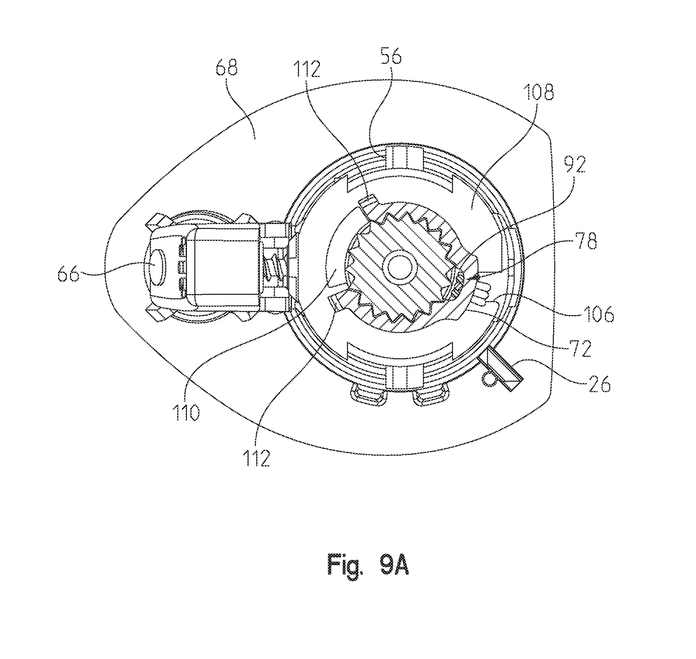

In the illustrated embodiment, waterway 56 is coupled to waterway adapter 61 of hose assembly 10 by coupling retainer 72 around waterway adapter 61 and fluid inlet 58. In one exemplary embodiment, retainer 72 is formed of a resilient material, such as plastic, thermoplastic, thermoset, or metal, and retainer is coupled around waterway adapter 61 and fluid inlet 58 by snapping retainer 72 into place, as illustrated in FIGS. 8 and 9.

In one exemplary embodiment, a first set of features of the waterway 56, retainer 72, and hose assembly 10 maintain a rotational position of the waterway 56 relative to a longitudinal axis of hose assembly 10. As illustrated in FIGS. 8-9A, waterway adapter 61 includes an exterior surface, such as plurality of projections forming a key 94, configured to cooperate with an interior surface of retainer 72, such as plurality of grooves forming a keyway 96, to prevent rotation of waterway adapter 61 and hose assembly 10 relative to retainer 72. In the illustrative embodiment, the projections of key 94 and recesses of keyway 96 comprise interlocking features or interlocking teeth to prevent rotation of waterway adapter 61 relative to retainer 72. Waterway 56 illustratively includes projections 110 extending from an exterior surface of fluid inlet 58. Projections 110 cooperate with longitudinal edges 112 of retainer 72 to prevent rotation of fluid inlet 58 and waterway 56 relative to retainer 72.

In one exemplary embodiment, a second set of features of the waterway 56, retainer 72, and hose assembly 10 maintain an axial position of the waterway 56 relative to a longitudinal axis of hose assembly 10. As illustrated in FIGS. 8-9A, waterway adapter 61 includes an annular recess 102 positioned below the key 94, configured to receive an upper ledge 98 of retainer 72 to prevent axial movement of waterway adapter 61 and hose assembly 10 relative to retainer 72. Waterway 56 illustratively includes annular recess 104 positioned below projections 110, configured to receive a lower ledge 100 of retainer 72 to prevent axial movement of fluid inlet 58 and waterway 56 relative to retainer 72.

Referring to FIG. 8, retainer 72 illustratively includes conduit guide 92 for receiving conduits 78, such as wires 78A-78C when retainer 72 is coupled around waterway adapter 61 and waterway 56. Conduit guide 92 is illustratively a channel extending along an interior surface retainer 72 parallel to a longitudinal axis of retainer 72. Waterway 56 illustratively includes conduit guide 106 for receiving conduits 78, such as wires 78A-78C. Conduit guide 106 is illustratively a gap in waterway plate 108 into which conduits 78 can be received.

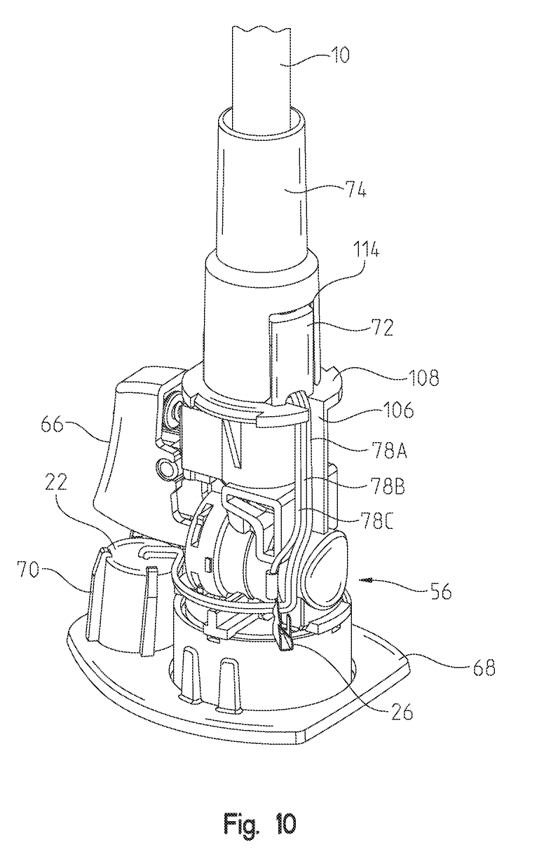

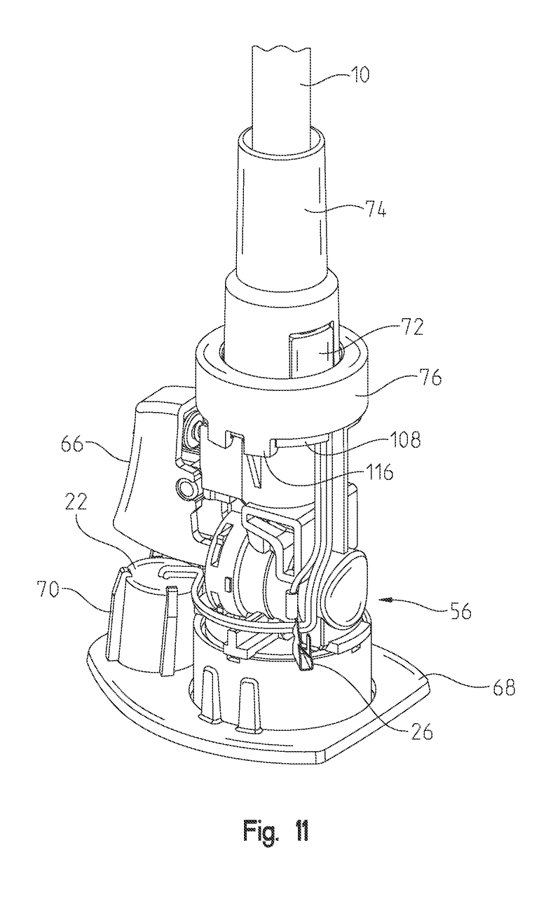

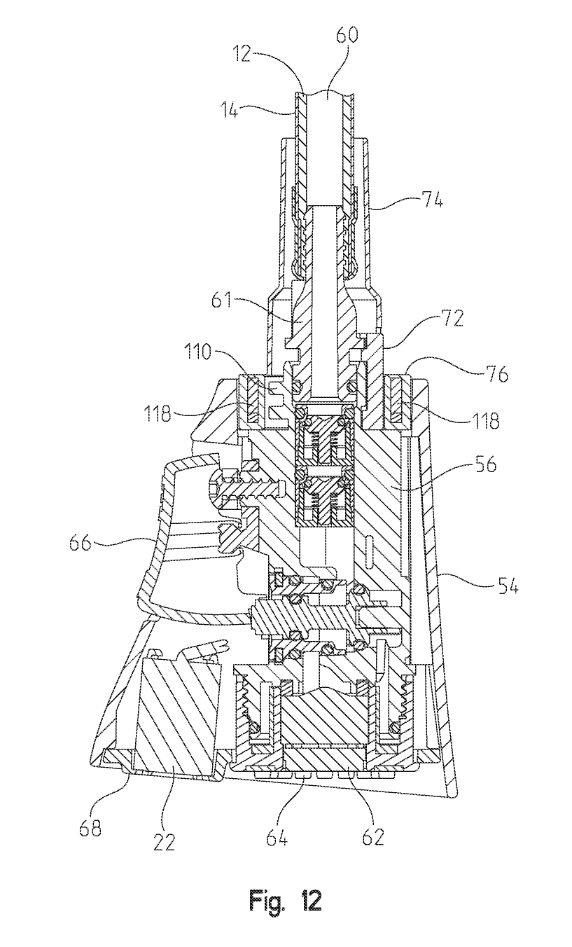

In one exemplary embodiment, illustrated in FIGS. 9 and 10, cover 74 is positioned over retainer 72. Cover 74 illustratively includes one or more cutouts 114 into which retainer 72 is received. Cover 74 illustratively covers the conduit 78 as it exits the overbraiding at radial outlet 34 and passes over ferrule 30. As illustrated in FIG. 11, retaining member 76 is then positioned over cover 74. Retaining member illustratively includes one or more clips 116, which slide over an edge of waterway plate 108, coupling retainer 72 to waterway 56. As shown in FIG. 12, retaining member 76 illustratively includes one or more magnets 118 or magnetically attractive elements, which are configured to releasably couple pullout sprayhead 52 to a magnet or magnetically attractive element in a faucet base (not shown).

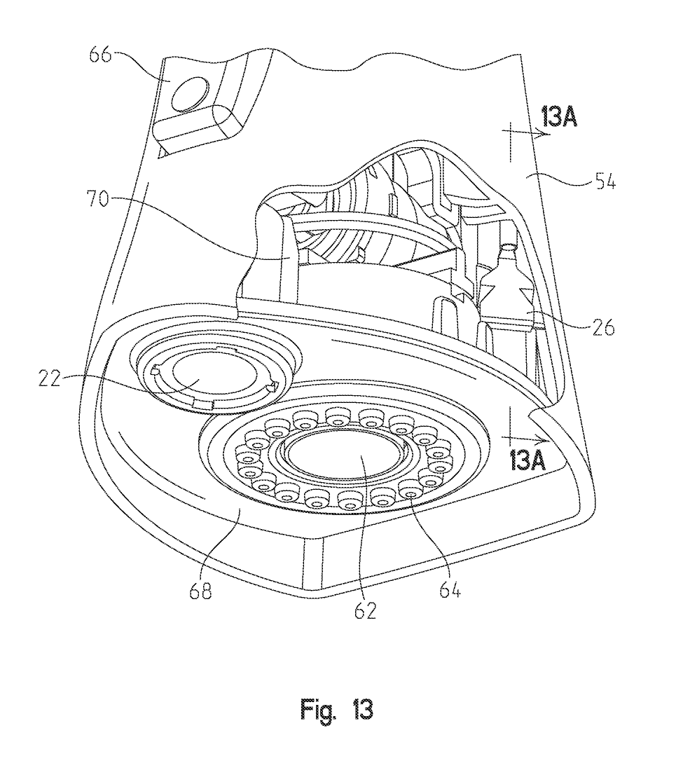

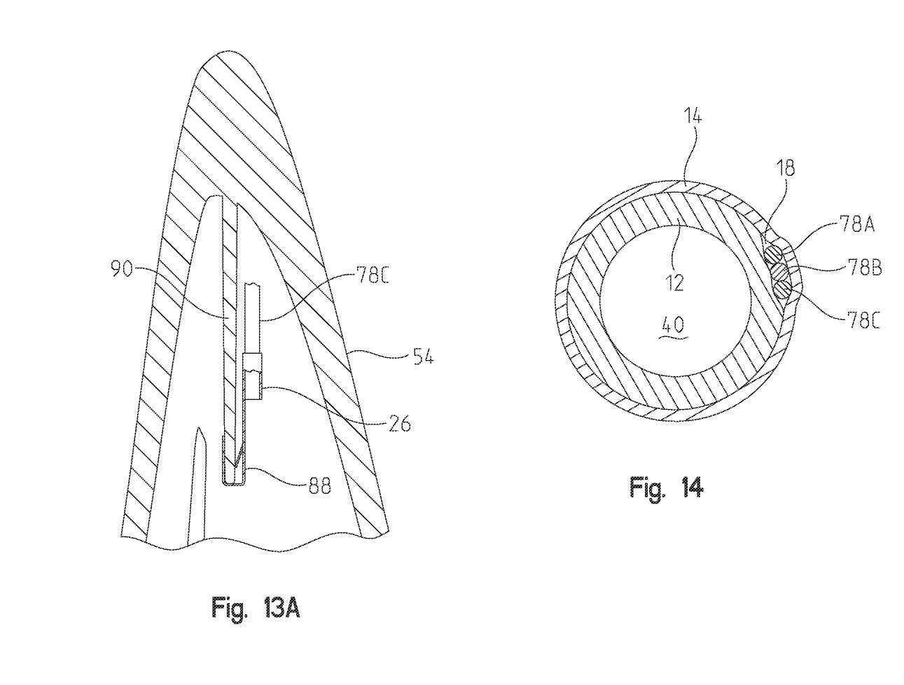

Referring back to FIG. 7, in one exemplary embodiment, sprayer assembly 50 includes one or more proximity or touch sensors. As shown in the exemplary embodiments in FIGS. 7, 15, and 16, sprayhead 52 includes an ultrasonic sensor 22 coupled to wires 78A and 78B. As illustrated, wire 78C is a portion of a capacitive touch sensor 20. As illustrated in FIG. 13A, wire 78C terminates at electrode 26, which is electrically coupled to cover 54 by clip 88. Clip 88 is illustratively attached to a projection 90 extending from an interior surface of cover 54.

In one embodiment of the present disclosure, a water faucet sprayer assembly is provided. The water faucet sprayer assembly comprising a hose assembly including a fluid conduit, at least one energy conducting conduit, and an exterior sheath, the fluid conduit and the at least one energy conducting conduit being covered along at least a portion of the hose assembly by the exterior sheath; a waterway having a fluid inlet and at least one fluid outlets, the fluid inlet of the waterway being in fluid communication with the fluid conduit of the hose assembly; at least one sensor coupled to the least one energy conducting conduit, the at least one sensor including at least one of a touch sensor and a proximity sensor; and a retainer removably coupled to the hose assembly and the waterway, the retainer having a conduit guide which receives and routes the at least one energy conducting conduit of the hose assembly between the hose assembly and the at least one sensor.

In one example, the retainer covers the at least one energy conducting conduit of the hose assembly. In another example, the exterior sheath includes a radial outlet through which the energy conducting conduit extends, the radial outlet being proximate to a first end of the exterior sheath and spaced apart from the first end of the exterior sheath. In a variation thereof, the hose assembly includes an adaptor received in the fluid conduit of the resilient interior tube; and a ferrule positioned over the exterior sheath, the ferrule being positioned closer to the first end of the exterior sheath than the radial outlet, the ferrule securing the adaptor to the resilient interior tube. In a refinement thereof, the water faucet sprayer assembly further comprises a cover which is movable along the longitudinal access of the hose assembly, the cover being positioned to cover the at least one energy conducting conduit as it passes over the ferrule. In another example, the retainer maintains an axial position of the waterway relative to a longitudinal axis of the hose assembly and a rotational position of the waterway relative to the longitudinal axis of the hose assembly.

In another exemplary embodiment of the present disclosure, a water faucet sprayer assembly is provided. The water faucet sprayer assembly comprising a hose assembly including a fluid conduit, at least one energy conducting conduit, and an exterior sheath, the fluid conduit and the at least one energy conducting conduit being covered along at least a portion of the hose assembly by the exterior sheath; a waterway having a fluid inlet and at least one fluid outlets, the fluid inlet of the waterway being in fluid communication with the fluid conduit of the hose assembly; at least one sensor coupled to the least one energy conducting conduit, the at least one sensor including at least one of a touch sensor and a proximity sensor; and a retainer removably coupled to the hose assembly and the waterway, the retainer maintaining an axial position of the waterway relative to a longitudinal axis of the hose assembly and a rotational position of the waterway relative to the longitudinal axis of the hose assembly.

In one example, the retainer engages an exterior surface of the waterway to maintain the axial position of the waterway relative to the longitudinal axis of the hose assembly. In a variation thereof, the retainer includes a lower ledge that clips under a ledge of the waterway to maintain the axial position of the waterway relative to the longitudinal axis of the hose assembly.

In another example, the retainer engages an exterior surface of the waterway to maintain the rotational position of the waterway relative to the longitudinal axis of the hose assembly. In a variation thereof, the retainer includes a keyway that receives a key of the waterway to maintain the rotational position of the waterway relative to the longitudinal axis of the hose assembly.

In a further example, the retainer engages an exterior surface of the hose assembly to maintain the axial position of the waterway relative to the longitudinal axis of the hose assembly. In a variation thereof, the retainer includes an upper ledge that clips over a ledge of the hose assembly to maintain the axial position of the waterway relative to the longitudinal axis of the hose assembly.

In still a further example, the retainer engages an exterior surface of the hose assembly to maintain the rotational position of the waterway relative to the longitudinal axis of the hose assembly. In a variation thereof, the retainer and the hose assembly include interlocking features to maintain the rotational position of the waterway relative to the longitudinal axis of the hose assembly. In a refinement thereof, the interlocking features are teeth.

In yet another example, a first set of features of the waterway, retainer, and hose assembly maintain the axial position of the waterway relative to the longitudinal axis of the hose assembly and a second set of features of the waterway, retainer, and hose assembly maintain the rotational position of the waterway relative to the longitudinal axis of the hose assembly. In a variation thereof, the first set of features in the absence of the second set of features would permit free rotation of the waterway relative to the hose assembly and the second set of features in the absence of the first set of features would permit free axial movement of the waterway relative to the hose assembly.

In still a further exemplary embodiment of the present disclosure, a method of coupling a waterway of a pull-out portion of a faucet to a hose assembly which is movably received within a body portion of the faucet is provided. The hose assembly includes a fluid conduit, at least one energy conducting conduit, and an exterior sheath. The fluid conduit and the at least one energy conducting conduit are covered along at least a portion of the hose assembly by the exterior sheath. The method comprising the steps of positioning the waterway relative to the hose assembly to place a fluid inlet of the waterway in fluid communication with the fluid conduit of the hose assembly; securing a removable retainer to the hose assembly and the waterway to retain the waterway relative to the hose assembly; and coupling the at least one energy conducting conduit of the hose assembly to at least one sensor of the pull-out portion of the faucet, the at least one sensor including at least one of a touch sensor and a proximity sensor.

In one example, the method further comprises the step of routing the at least one energy conducting conduit through a conduit guide of the retainer. In another example, the securing step includes the steps of engaging an exterior surface of the waterway with the retainer; and engaging an exterior surface of the hose assembly with the retainer.

While this disclosure has been described as having exemplary designs, the present disclosure can be further modified within the spirit and scope of this disclosure. This application is therefore intended to cover any variations, uses, or adaptations of the disclosure using its general principles. Further, this application is intended to cover such departures from the present disclosure as come within known or customary practice in the art to which this disclosure pertains and which fall within the limits of the appended claims.

1. A water faucet hose assembly comprising:
a first fiber formed of a first material;
a second fiber formed of a second material configured to conduct energy, said first fiber and said second fiber interwoven with one another to define a braided exterior sheath defining a longitudinal axis; and
a resilient interior tube concentrically received within said sheath.

2. The water faucet hose assembly of claim 1, wherein said second material comprises one of silica and plastic.

3. The water faucet hose assembly of claim 1, wherein said second fiber comprises a fiber optic cable configured to conduct light.

4. The water faucet hose assembly of claim 3, wherein said fiber optic cable is configured to emit light at a plurality of positions intermediate opposing ends of said cable.

5. The water faucet hose assembly of claim 1, wherein said second fiber comprises an electrically conductive wire.

6. The water faucet hose assembly of claim 5, wherein the electrically conductive wire includes a first electrically conductive wire coupled to an ultrasonic sensor, and a second wire coupled to a capacitive sensor.

7. The water faucet hose assembly of claim 6, wherein the ultrasonic sensor and the capacitive sensor are received within a pull-out sprayhead removably coupled to a faucet spout.

8. A water faucet hose assembly comprising:
an exterior sheath defining a longitudinal axis, the exterior sheath being a polymer braid;
a resilient interior tube concentrically received within said sheath;
a space defined between said sheath and said tube, said space extending parallel to said exterior sheath and said resilient interior tube; and
at least one energy conducting conduit extending through said space.

9. The water faucet hose assembly of claim 8, wherein said at least one energy conducting conduit comprises a fiber optic cable configured to conduct light.

10. The water faucet hose assembly of claim 9, wherein said fiber optic cable is configured to emit light at a plurality of positions intermediate opposing ends of said cable.

11. The water faucet hose assembly of claim 8, wherein said at least one energy conducting conduit comprises an electrically conductive wire.

12. The water faucet hose assembly of claim 11, wherein the electrically conductive wire includes a first electrically conductive wire coupled to an ultrasonic sensor, and a second wire coupled to a capacitive sensor.

13. The water faucet hose assembly of claim 12, wherein the ultrasonic sensor and the capacitive sensor are received within a pull-out sprayhead removably coupled to a faucet spout.

14. The water faucet hose assembly of claim 8, wherein the tube is formed of a polyethylene.

15. A water faucet hose assembly comprising:
a resilient interior tube having a fluid conduit extending therethrough;
an exterior sheath covering a length of the resilient interior tube, the exterior tube being constructed of braided threads; and
at least one energy conducting conduit positioned between the exterior sheath and the resilient interior tube, the exterior sheath including a radial outlet through which the energy conducting conduit extends, the radial outlet being proximate to a first end of the exterior sheath and spaced apart from the first end of the exterior sheath.

16. The water faucet hose assembly of claim 15, further comprising:
an adaptor received in the fluid conduit of the resilient interior tube; and
a ferrule positioned over the exterior sheath, the ferrule being positioned closer to the first end of the exterior sheath than the radial outlet, the ferrule securing the adaptor to the resilient interior tube.

17. The water faucet hose assembly of claim 16, wherein the exterior sheath is a polymer braid.

18. The water faucet hose assembly of claim 16, wherein the at least one energy conducting conduit includes at least one electrical wire, the at least one electrical wire being coupled to a proximity sensor of a sprayhead.

19. The water faucet hose assembly of claim 18, wherein the proximity sensor is one of an ultrasonic sensor and a capacitive sensor.

20. The water faucet hose assembly of claim 16, wherein the at least one energy conducting conduit includes an optical fiber.
